(19) United States
(12) Patent Application Publication
(10) Pub. No.: US 2016/0108215 A1
(43) Pub. Date: Apr. 21, 2016

(54) COMPOSITIONS CONTAINING GROUND VULCANIZED RUBBER AND HIGH MELT FLOW POLYMER

(71) Applicant: Edgar A Gonzalez, Creston, OH (US)

(72) Inventor: Edgar A Gonzalez, Creston, OH (US)

(21) Appl. No.: 14/886,037

(22) Filed: Oct. 17, 2015

Related U.S. Application Data
(60) Provisional application No. 62/065,626, filed on Oct. 18, 2014.
(60) Provisional application No. 62/232,758, filed on Sep. 25, 2015.

(51) Int. Cl. C08L 17/00

(52) U.S. Cl. CPC C08L 17/00; C08L 2205/03; C08L 2207/20

(57) ABSTRACT

Improved thermoplastic compositions comprising a blend of ground vulcanized rubber and an alpha olefin copolymer which have improved compatibility and properties are described; they are improved by incorporation of a high melt flow index polypropylene homopolymer.

### TECHNICAL FIELD

This invention relates to improved thermoplastic compositions which, while having the processability of a thermoplastic polymer, are elastomeric in nature. The result of this invention is accomplished by melt mixing ground vulcanized rubber with an alpha olefin copolymer in the presence of a high melt flow index homopolymer polypropylene polymer.

### DESCRIPTION OF THE PRIOR ART

Thermoplastic compositions consisting of blends of ground vulcanized rubber and thermoplastic polymer are known; for example see U.S. Pat. No. 6,031,009. That patent discloses improved compositions comprising a blend of ground vulcanized rubber and olefin polymer obtained by the incorporation of an alpha olefin copolymer. However, there is a definite need for improved blends of ground vulcanized rubber and thermoplastic polymer in light of the large number of discarded tires and waste rubber articles which are not being reclaimed. As will be shown in a comparative example below the mechanical properties of the '009 compositions (i.e. true stress at break) are inferior relative to the mechanical properties of the compositions of the present invention. U.S. Pat. No. 5,157,082 describes compositions comprising a blend of ground vulcanized rubber, olefin polymer and a functionalized olefin polymer. That patent, however, is not pertinent in that the composition does not contain the alpha olefin copolymer.

The quality of a rubber-plastics blend depends partly upon the mutual compatibility between the components. Much work is being done to continue to improve the properties of these blends including blends of ground vulcanized rubber from discarded tires and other scrap rubber products with thermoplastic polymers. If the properties of such blends can be improved, additional uses for the scrap rubber can be found.

Each year, in the U.S. alone, more than 300 million used tires are discarded. This, in addition to an estimated 3 billion tires that already exist in stock piles. Above ground storage of tires presents a fire and health hazard. Once ignited, a pile of tires can burn for months, polluting the air with black smoke and strong odor. Tires constitute an ideal breathing ground for disease carrying mosquitoes and rats. These hazards are well documented in various tire studies sponsored by the EPA and other federal and state agencies.

### SUMMARY OF THE INVENTION

In accordance to this invention, it has been discovered that thermoplastic compositions comprising a blend of ground vulcanized rubber, alpha olefin copolymer and a high melt flow index homopolymer polypropylene polymer of about 30 melt flow index (230° C./2.16 kg) or above unexpectedly have improved toughness, flow and surface appearance compared to blends of similar composition containing a copolymer of polypropylene and ethylene of similar or lower melt flow index (230° C./2.16 kg) or a homopolymer polypropylene of significantly lower melt flow index (230° C./2.16 kg). The improved properties of the compositions of the present invention indicate improved compatibility between the ground vulcanized rubber and the other components in the blend. More specifically, improved thermoplastic compositions of the invention comprise (a) ground vulcanized rubber in the form of small dispersed particles, (b) alpha olefin copolymer and (c) high melt flow index homopolymer polypropylene polymer of about 30 melt flow index (230° C./2.16 kg) or above, and, if desired, additives such as fillers, pigments, reinforcements, stabilizers, processing aids, colorants, plasticizers and other compounding or modifying ingredients may be included in order to meet specific performance needs of each customer.

The melt processability of these compositions allows shaped articles of these compositions to be molded there from without the time consuming cure step required with conventional thermoset rubbers, thereby, reducing finished part cost.

### DESCRIPTION OF THE PREFERRED EMBODIMENTS

Component (a) is mechanically or cryogenically ground vulcanized rubber in the form of small particles essentially of 1.5 mm number average or below and more preferably a particle size between 0.1 mm and 1.0 mm number average. Exemplary of the vulcanized rubber include natural rubber, synthetic polymer and copolymer rubber derived from alkadienes, and mixtures thereof. For economic reasons, ground vulcanized rubber from scrap tires, retreaded tire buffing, tire tubes, and miscellaneous waste thermoset rubber articles, with subsequent removal of ferrous constituents and other contaminants, is especially preferred for purposes of the subject invention.

The alpha olefin copolymer listed as component (b) is a copolymer of at least one olefin and one or more alpha olefins. Preferred olefins include ethylene, propylene, butadiene, isoprene, including hydrogenated butadiene and isoprene. Preferred alpha olefins in accordance to this invention are alpha olefins containing 2-10 carbon atoms. Examples of such alpha olefins are 1-butene, 1-pentene, 4-methyl-1-pentene, 5-methyl-1-hexene, 1-octene, or mixtures thereof. Of course, more than one of these alpha olefins may be copolymerized with an olefin to form the alpha olefin copolymer useful in the practice of the subject invention. Preferred alpha olefin copolymers contain at least one olefin copolymerized with one or more alpha olefins using single-site catalysts. Examples of such catalysts are matallocene single-site catalysts, which make polymers with uniform, narrow molecular distribution and higher comonomer content compared to Ziegler-Natta catalysts. Examples of alpha olefin copolymers are copolymers of ethylene and 1-butene available from Exxon Chemical Company under the trade name EXACT and copolymers of ethylene and 1-hexene available from Union Carbide under the trade name FLEXOMER. The industrial technology that is used for making single-site olefin copolymers is known and is covered in several U.S. patents. Examples of such technology include U.S. Pat. No. 5,272,236 issued December, 1993 and U.S. Pat. No. 5,278,272 issued January, 1994. Generally, the amount of alpha olefin monomer is used at a rate of about 0.5 to 30 parts by weight per 100 parts by weight of alpha olefin copolymer.

The high melt flow index homopolymer polypropylene polymer listed as component (c) is a homopolymer of polypropylene of about 30 melt flow index (230° C./2.16 kg) or above made by polymerizing polypropylene monomer. Examples of methods to synthesize homopolymer polypropylene include the use of Ziegler-Natta catalysts and/or matallocene catalysts. Examples of homopolymer polypropylene manufacturing methods include suspension, bulk slurry and gas phase reactor polymerization. The high melt flow index homopolymer polypropylene can also be manufactured by breaking the molecular chains of the lower melt flow homopolymer polypropylene which decreases the molecular weight of the lower melt homopolymer polypropylene. This decrease in molecular weight results in an increase in the melt flow index (MFI). This process which degrades the polymer is called “controlled rheology (CR) by chain scission”. An example of a chain scission method is reacting homopolymer polypropylene polymer with peroxides. By introducing various peroxides—which act as catalysts to the degradation process—at controlled rates, resin manufacturers can control the amount of degradation. Preferred high melt flow index homopolymer polypropylene has a melt flow index in the range of 35 to 55 (230° C./2.16 kg).

Although not essential components of the compositions of this invention, various amounts of any number of conventional fillers or compounding ingredients may be admixed. Examples of such ingredients include various carbon blacks, clay, silica, alumina, calcium carbonate, titanium dioxide, pigments, flame retardants, reinforcements, stabilizers, curing agents, antioxidants, anti-degradants, tackifiers, processing aids such as lubricants and waxes, plasticizers, etc. The amount used depends, at least in part, upon the quantities of the ingredients in the composition.

A blend composition of the present invention may be manufactured in a single operation or in a number of operational steps. In the single step operation the vulcanized rubber particles, the alpha olefin copolymer and the high melt flow index homopolymer polypropylene polymer, with the necessary fillers and additives are charged at the desired rates to a suitable mixer, for example, a Banbury internal mixer, two roll mill or extruder, or any device that will allow efficient mixing of the blend at the desired temperature to obtain a composition of the invention. Alternatively, as an example of a multistep operation, a composition of the invention may be prepared by first separately mixing a blend of ground vulcanized rubber and alpha olefin copolymer. The independently prepared blend is then melt mixed together with the high melt flow index homopolymer polypropylene in conventional mixing equipment to obtain a composition of the invention. The blending is done at a temperature high enough to soften the polymers for adequate blending, but not so high as to degrade the polymers. Generally speaking, this blending temperature ranges from 140 to 200 C, and blending is carried out for a time sufficient to homogeneously blend the components.

In accordance to this invention, the relative proportions of the vulcanized rubber particles, alpha olefin copolymer and high melt flow index homopolymer polypropylene polymer depend, at least in part, upon the type of molecular weight of the rubber, alpha olefin copolymer and high melt flow index homopolymer polypropylene polymer, and the presence of other ingredients in the composition such as filler, reinforcements, plasticizers, etc. In general, the compositions of the invention comprise about 10-90 parts by weight of ground vulcanized rubber, about 0.5-80 parts by weight of one or more metallocene catalyzed alpha olefin copolymer and about 90-10 parts by weight of high melt flow index homopolymer polypropylene polymer of 30 melt flow index (230° C./2.16 kg) or above. Compositions comprising about 20 to about 80 parts by weight of ground vulcanized rubber, 0.5-50 parts by weight of alpha olefin copolymer and about 80 to about 20 parts by weight of high melt flow index homopolymer polypropylene polymer of 30 melt flow index (230° C./2.16 kg) or above are preferred.

The blend compositions of the subject invention are melt processable using conventional plastic processing equipment. The properties of the blend depend upon the properties of the components with a wide range of properties being available simply by varying the proportions of the blend components. Blends containing high proportions of ground vulcanized rubber are elastoplastic, which means they are elastomeric, but can be processed using conventional plastic processing equipment. In addition, the melt processability of these compositions allowed shaped articles of these compositions to be molded there from without the time consuming cure step required with conventional rubbers, thereby reducing finished part cost significantly. Blends containing high proportions of high melt flow index homopolymer polypropylene polymer are moldable, rigid thermoplastic compositions exhibiting improved impact resistance. Since in-process scrap can be remelted and recycled there is no waste, resulting in additional cost savings. The thermoplastic nature of the compositions of the present invention enables shaped articles made from such compositions to be recycled in the same manner as conventional thermoplastics, thus helping to alleviate the growing environmental problem of solid waste disposal. In addition, the composition of the subject invention is adaptable to reprocessing of vulcanized rubber form scrap tires and, therefore, it can serve environmental protection by reducing solid waste and the fire/health hazards associated with above ground storage of tires. Improved compositions of the inventions can be used to form a variety of molded, extruded, or calendered articles. Various uses for the compositions of the invention include seals and gaskets, automotive parts, anti-skid surfaces, and reinforced hoses. They can be used to coat fabric, industrial belts and various hard surfaces by extrusion coating. They also find utility as impact modifiers for other polymer systems. Compositions within the scope of this invention can be used as the protective covering of reinforced or unreinforced tubes of similar or different compositions.

The subject invention will be more fully appreciated with reference to the examples that follow. In the stated nonrestrictive examples all percentages are by weight of total composition unless otherwise indicated.

### Example 1

The vulcanized rubber particles were obtained by grinding ethylene-propylene-diene monomer (EPDM) rubber scrap from recycled hoses and gaskets. The average particle size was 0.5 mm. The rubber particles, alpha olefin copolymer and high melt flow index homopolymer polypropylene polymer were mixed in a Banbury mixer at 180-190 C for five minutes. After blending and pelletizing, to demonstrate that the compositions were melt processable, each batch was injection molded into a four inch disc 2.0 mm thick. The molded disc was rapidly cooled under pressure to ambient temperature and removed from the press.

Test specimens were die cut from the molded disc and used after 24 hours storage at room temperature. The molded disc samples were re-melt processable.

The stress-strain properties of the compositions are determined in accordance with the procedures set forth in ASTM D-412. Test specimens are pulled with an Instron Tester at 20.0 inches per minute to failure. The properties are shown in Table 1. True stress at break (TSB) is the tensile strength (TS) at break multiplied by the extension ratio also at break. Extension ratio is the length of a tensile test specimen at break divided by the original, unstressed length of the test specimen. Alternately, extension ratio is 1.00 plus 1/100 of the percent ultimate elongation (EL). An increase of 15%, preferably 25% or more, in TSB indicates improved compatibility.

Blend compositions are prepared which contain the ingredients in Table 1. Batch A contains a copolymer polypropylene with a 20 MFI. Batch B contains a copolymer polypropylene with a 30 MFI. Batch B produced with the higher melt flow index copolymer polypropylene has inferior mechanical properties compared to Batch A produced with the lower melt flow index copolymer polypropylene. Batch C illustrates an improved composition of the invention.

The data show that the incorporation of a high melt flow index homopolymer polypropylene polymer results in substantial improvement in TSB over the copolymer polypropylene with a significantly lower melt flow (35% increase over Batch A) and over the copolymer polypropylene with a similar melt flow (43% increase over Batch B).

TABLE 1

| | A | B | C |
|---|---|---|---|
| Rubber (1) | 50.0 | 50.0 | 50.0 |
| COPP (2) | 12.5 | — | — |
| COPP (3) | — | 12.5 | — |
| HPP (4) | — | — | 12.5 |
| E/1-OCTENE (5) | 17.5 | 17.5 | 17.5 |
| Plasticizer (6) | 20.0 | 20.0 | 20.0 |
| Shore Hardness (7) | 72A | 68A | 72A |
| Tensile at Break, psi (8) | 532 | 467 | 676 |
| Elongation at break, % (8) | 418 | 416 | 530 |
| M100, psi (8) | 308 | 277 | 355 |
| TSB (9) | 2756 | 2410 | 4259 |

1. Rubber = Recycled EPDM from hoses and gaskets, 0.5 mm average particle size
2. COPP = Ethylene-polypropylene copolymer, 20 MFI (230° C./2.16 kg)
3. COPP = Ethylene-polypropylene copolymer, 30 MFI (230° C./2.16 kg)
4. HPP = Polypropylene homopolymer, 35 MFI (230° C./2.16 kg)
5. E/1-OCTENE = Ethylene/1-Octene copolymer
6. Plasticizer = liquid additive
7. ASTM D-2240
8. ASTM D-412
9. TSB = True stress at break = TS (1 + EL/100)

### Comparative Example 2

By the same procedure as Example 1, the following compositions were blended (values are in weight percent). Batch A was prepared using the same homopolymer propylene as Example 1 Batches A and C of U.S. Pat. No. 6,031,009. The results show that, Batch B produced with the higher melt flow index homopolymer polypropylene unexpectedly has superior mechanical properties over Batch A produced with the much lower melt flow/higher molecular weight homopolymer polypropylene (Table 2).

TABLE 2

| | A | B |
|---|---|---|
| Rubber (1) | 50.0 | 50.0 |
| HPP (2) | — | 10.0 |
| HPP (3) | 10.0 | — |
| E/1-OCTENE (4) | 20.0 | 20.0 |
| Plasticizer (5) | 20.0 | 20.0 |
| Shore Hardness (6) | 69A | 68A |
| Tensile at Break, psi (7) | 568 | 647 |
| Elongation at break, % (7) | 386 | 536 |
| M100, psi (7) | 294 | 299 |
| TSB (8) | 2760 | 4115 |

1. Rubber = Recycled EPDM from hoses and gaskets, 0.5 mm average particle size
2. HPP = Polypropylene homopolymer, 35 MFI (230° C./2.16 kg)
3. HPP = Polypropylene homopolymer, 0.6 MFI (230° C./2.16 kg), D007W from Sunoco
4. E/1-OCTENE = Ethylene/1-Octene copolymer
5. Plasticizer = liquid additive
6. ASTM D-2240
7. ASTM D-412
8. TSB = True stress at break = TS (1 + EL/100)

Although the invention has been illustrated by typical examples, it is not limited thereto. Changes and modifications of the examples of the invention herein chosen for the purpose of disclosure can be made which do not constitute departure from the spirit and scope of the invention.

What is claimed is:

1. Improved thermoplastic compositions comprising a blend of about 10-90 parts by weight of ground vulcanized rubber in the form of small dispersed particles essentially of 1.5 mm number average or below, wherein said rubber is selected from the group consisting of natural rubber, synthetic polymer and copolymer rubber derived from alkadienes, and mixtures thereof, about 0.5-80 parts by weight of one or more metallocene catalyzed alpha olefin copolymer and about 90-10 parts by weight of high melt flow index homopolymer polypropylene polymer of 30 melt flow index (230° C./2.16 kg) or above.

2. The composition of claim 1 wherein the ground vulcanized rubber is obtained by grinding scrap tires, retreaded tire bugging, tire tubes or waste thermoset rubber articles.

3. The composition of claim 1 wherein is incorporated 0-300 parts by weight percent based on the composition of one or more additives, selected from the group consisting of carbon black, clay, silica, alumina, calcium carbonate, titanium dioxide, pigments, flame retardants, antioxidants, antidegradents, tackifiers, reinforcing materials, lubricants, waxes, and plasticizers.

4. The composition of claim 1 wherein the alpha olefin copolymer is a copolymer of one or more olefins selected from the group consisting of ethylene, propylene, butadiene and isoprene and one or more alpha olefins selected from the groups consisting of 1-butene, 1-pentene, 1-hexene, 2-methyl-1propene, 3-methyl-1-pentene, 4-methyl-1-pentene, 5-methyl-1-hexene and 1-octene.

5. The composition of claim 1 wherein said high melt flow index homopolymer of polypropylene polymer is made by polymerizing polypropylene monomer.

6. A process for manufacturing improved thermoplastic compositions which comprises mixing a blend of about 10-90 parts by weight of ground vulcanized rubber in the form of small dispersed particles essentially of 1.5 mm number average or below, wherein said rubber is selected from the group consisting of natural rubber, synthetic polymer and copolymer rubber derived from alkadienes, and mixtures thereof, about 0.5-80 parts by weight of one or more metallocene catalyzed alpha olefin copolymer and about 90-10 parts by weight of high melt flow index homopolymer polypropylene polymer of 30 melt flow index (230° C./2.16 kg) or above at a temperature high enough to soften or melt the polymers, and for sufficient time to obtain a homogeneous mixture.

7. The process of claim 6 wherein the ground vulcanized rubber is obtained by grinding scrap ties, retreaded tire buffing, tire tubes and waste thermoset rubber articles.

8. The process of claim 6 wherein is incorporated 0-300 parts by weight percent based on the composition of one or more additives, selected from the group consisting of carbon black, clay, silica, alumina, calcium carbonate, titanium dioxide, pigments, flame retardants, antioxidants, antidegradents, tackifiers, reinforcing materials, lubricants, waxes, and plasticizers.

9. The process of claim 6 wherein the alpha olefin copolymer is a copolymer of one or more olefins selected from the group consisting of ethylene, propylene, butadiene and isoprene and one or more alpha olefins selected from the groups consisting of 1-butene, 1-pentene, 1-hexene, 2-methyl-1propene, 3-methyl-1-pentene, 4-methyl-1-pentene, 5-methyl-1-hexene and 1-octene.

10. The process of claim 6 wherein said high melt flow index homopolymer of polypropylene polymer is made by polymerizing polypropylene monomer or by molecular chain scission of a lower melt flow index homopolymer polypropylene polymer.

11. Articles manufactured from the compositions of claim 1.
